(19) United States
(12) Patent Application Publication
(10) Pub. No.: US 2014/0089096 A1
(43) Pub. Date: Mar. 27, 2014

(54) METHOD AND APPARATUS FOR USING IDENTIFIERS ASSOCIATED WITH PRODUCTS FOR APPLYING A MOBILE DEVICE SKIN

(71) Applicant: Interroband Group LLC, Malibu, CA (US)

(72) Inventor: Adrian Van Anz, Los Angeles, CA (US)

(21) Appl. No.: 14/030,966

(22) Filed: Sep. 18, 2013

Related U.S. Application Data
(60) Provisional application No. 61/704,187, filed on Sep. 21, 2012.

(51) Int. Cl. G06Q 30/02; H04M 1/02

(52) U.S. Cl. CPC G06Q 30/0267; H04M 1/0202
USPC 705/14.64; 455/575.1; 705/14.16

(57) ABSTRACT

A system and method for applying a skin to a mobile device is described. The mobile device includes a camera and a rear screen. The method analyzes an image captured by the camera to detect an identifier and associates the identifier with a product or a vendor. A skin representing the product or vendor is applied to the rear screen of the mobile device and posted to a social networking website, such that the user may express their personal sense of affinity toward a product, an artist, or an organization.

### RELATED MATTERS

This application claims the benefit of the earlier filing date of provisional application No. 61/704,187, filed Sep. 21, 2012.

### BACKGROUND

Consumers often have a preference for a brand or a company. This esteem can lead to a desire to identify with the brand or company. For example, consumers or fans of Ducati motorcycles may express their appreciation for Ducati products by placing a Ducati branded physical cover or skin on their phone or mobile device. Although physically affixing a logo to display affinity for a brand is somewhat effective, this fixed exhibition does not allow a consumer to easily and efficiently switch between brand endorsements. For example, a consumer may want to display a Ducati logo during the daytime while riding her Ducati motorcycle and wearing a Ducati branded jacket, but may want to switch to a Cole Haan logo or design at night while carrying her Cole Haan handbag. In this situation, using the traditional system of replacing covers and skins is cumbersome and inefficient.

### BRIEF DESCRIPTION OF THE DRAWINGS

Embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one.

FIGS. 1A and 1B show front and rear views of a mobile device according to one embodiment.

FIGS. 2A, 2B, and 2C show multiple views of the mobile device with a cover according to another embodiment.

FIG. 3 shows a component diagram of the mobile device according to one embodiment.

FIG. 4 shows a method for applying a skin to the mobile device according to one embodiment.

FIG. 5 shows example data structures and components of a mobile skin application and a remote application according to one embodiment.

FIG. 6 shows an image captured by the camera that includes an identifier.

FIG. 7A shows an example skin that is generated/designed by a vendor according to one embodiment.

FIG. 7B shows a skin being used on the rear screen according to one embodiment.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

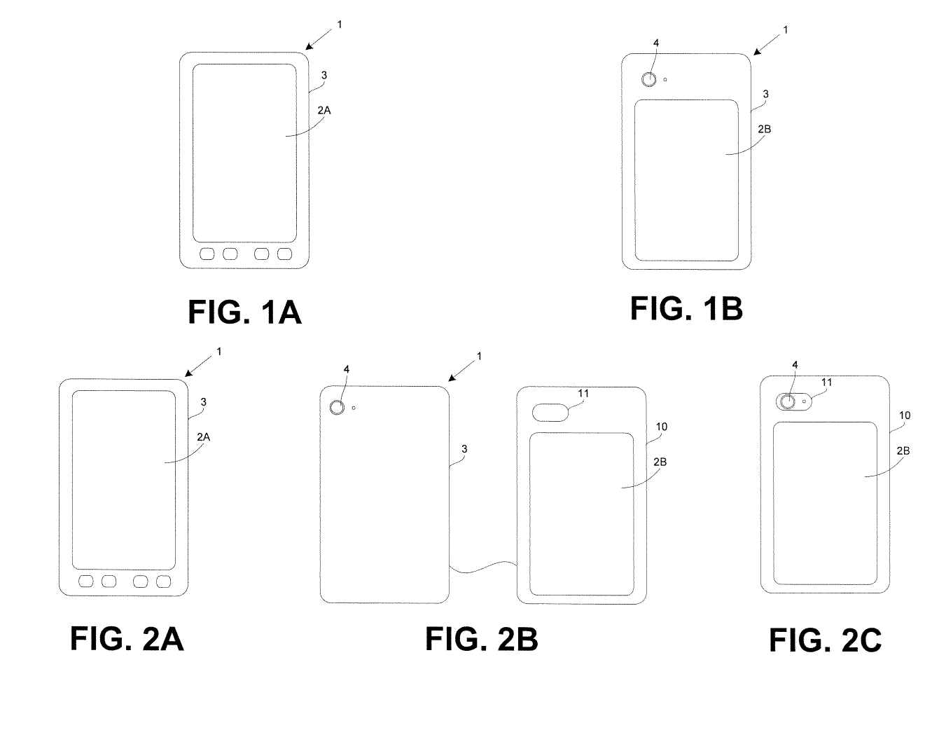

FIGS. 1A and 1B respectively show front and rear views of a mobile device 1 according to one embodiment. As shown, the mobile device 1 includes separate front and rear screens 2A and 2B integrated within a housing 3 of the device 1. The housing 3 is essentially a solid volume referred to as candy bar or chocolate bar type. The screens 2A and 2B in this embodiment are integrated into the housing 3 of the mobile device 1 during manufacture and the mobile device 1 is able to natively control the operation of each screen 2A and 2B without the assistance of additional software, hardware, or accessories.

In one instance, the mobile device 1 is a smart phone or a cellular phone with several features typically available in modern wireless communication devices, such as music playback, image viewing and capture, video playback and capture, voice dictation, and wireless-enabled applications such as voice over internet protocol telephony, video conferencing, electronic calendar, web browser, and email. For example, the mobile device 1 may be a Windows Mobile or Android enabled phone. In another instance, the device 1 may be a larger, tablet-like computer such as an iPad™ device by Apple Inc.

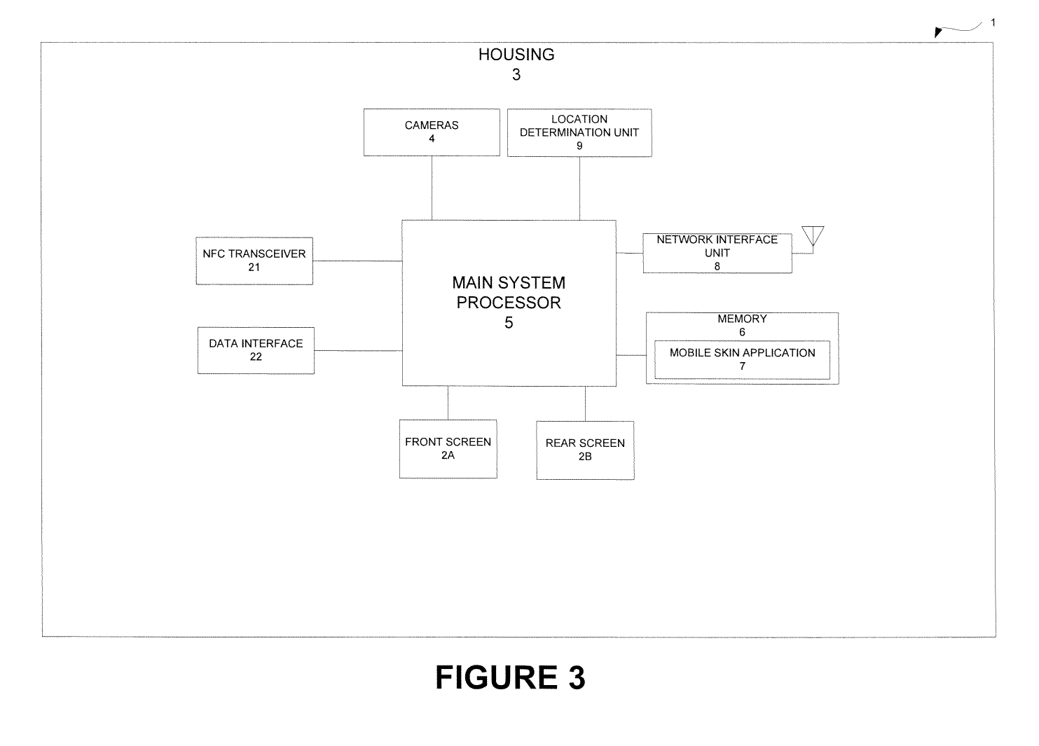

FIG. 3 shows a component diagram of the mobile device 1 according to one embodiment. The components shown in FIG. 3 are illustrative and the mobile device 1 may include additional components for performing the operations discussed below. Each component in FIG. 3 will be described below.

The mobile device 1 includes one or more cameras 4 integrated into the housing 3. The cameras 4 may be any camera type suitable for being integrated in the mobile device 1, including charge-coupled device (CCD) and complementary metal-oxide-semiconductor (CMOS) cameras. The cameras 4 may be separately located on front and rear faces of the device 1 and accordingly directed at respective front and rear areas of the device 1 such that a corresponding application running on the device 1 may use one or both of the captured scenes. For example, the cameras 4 may be used to capture a product in a store, a famous piece of art in a museum, or a family portrait. The cameras 4 may capture any style/type of image or photo, including color images, black and white images, high dynamic range (HDR) images, and three-dimensional images. The captured images may be stored in a local image store on the mobile device 1 in any format, including Joint Photographic Experts Group (JPEG) format, JPEG 2000 format, JPEG extended range (JPEF XR) format, Portable Network Graphics (PNG) format, Exchangeable image file format (Exif), Tagged Image File Format (TIFF), RAW, Netpbm format, Radiance HDR format, Multi Picture Object (MPO) format, or PNG Stereo (PNS) format.

The user-level functions of the device 1 are implemented under control of a main system processor 5 that has been programmed in accordance with instructions (code and data) stored in memory 6. The processor 5 and the memory 6 are generically used here to refer to any suitable combination of programmable data processing components and data storage that conduct the operations needed to implement the various functions of the device 1. The processor 5 may be an applications processor typically found in a smart phone, while the memory 6 may refer to microelectronic, non-volatile random access memory. An operating system may be stored in the memory 6, along with application programs specific to the various functions of the device 1, which are to be run or executed by the processor 5 to perform the various functions of the device 1. For instance, there may be a telephony application that (when launched, unsuspended, or brought to foreground) enables the user to “dial” a telephone number to initiate a telephone call using a wireless VOIP or a cellular protocol and to “hang up” on the call when finished.

In one embodiment, a mobile skin application 7 may be located in the memory 6 and run by the processor 5. The mobile skin application 7 allows a user to apply a skin to the mobile device 1 based on a product or company identified by the skin application 7 (e.g., captured by the camera 4). A skin may be comprised of one or more images, animations, and sounds that may be integrated into the interface of the mobile device 1. For example, a skin may include a background image or wallpaper that is applied to the rear screen 2B of the device 1. In one embodiment, the rear screen 2B of the mobile device 1 is active independent of the front screen 2A. For example, while the mobile device 1 is placing a call and the front screen 2A is turned off, the rear screen 2B may be active and displaying a logo of a vendor (e.g., a Ducati logo) or a design of a particular product (e.g., the design pattern of a particular Cole Haan handbag). This display of a vendor's logo or design allows the user a revolutionary new way to express their personal sense of affinity toward a product, an artist, or an organization by skinning the outward facing rear screen 2B of their mobile device 1 creating walking digital billboards all around the world. Users will instantly be able to transform the look of their mobile device 1 to match their mood, their outfit, their accessories, their favorite music artist, or aid organization, even their mode of transportation to coordinate their mobile device 1 to a product or brand that they identify with. The mobile skin application 7 will be described in further detail below, including the different techniques for selecting skins based on identification of products and vendors by the mobile device 1.

In one embodiment, the mobile skin application 7 applies an image captured by the camera 4 or a stored image to the rear screen 2B. For example, the mobile skin application 7 may detect the capture of an image by the camera 4 and apply the image as a background/wallpaper image for the rear screen 2B. The image file may be scaled, cropped, color adjusted, or otherwise modified by the mobile application 7 before being applied to the rear screen 2B. In another example, the mobile skin application 7 may prompt the user for an image file locally stored on the mobile device 1 or remotely stored on a server. For instance, the image file selected by a user may be stored remotely on a server (e.g., stored on a file or image sharing website or cloud storage service), captured by the camera 4 and stored in local memory on the device 1 (e.g., a camera roll or image store) or otherwise stored locally on the device 1 or accessible by the device 1. Files stored on the device 1 may be in any style/type (e.g., color images, black and white images, high dynamic range (HDR) images, and three-dimensional images) or format (e.g., JPEG format, JPEG 2000 format, JPEF XR format, PNG format, Exif, TIFF, RAW, Netpbm format, Radiance HDR format, MPO format, and PNS format). Upon selection of either a captured or stored image, the selected image may be applied as a wallpaper to the rear screen 2B of the mobile device 1.

Although primarily described herein as being related to a purchasable product, the selected or captured image may be unrelated to a product. For example, the selected or captured image may be a family photo or an artistic expression. Regardless of content, an image may be applied to the rear screen 2B to display the user's affinity or connection to a representation shown therein.

In one embodiment, the mobile device 1 includes network interface unit 8 for allowing the mobile device 1 to communicate with remote devices over a network. The network interface unit 8 may be capable of accessing one or more local or remote networks using standard protocols to access remote devices/servers or be accessed by remote devices/servers. For example, the network interface unit 8 may be capable of communicating with a remote server using one or more of TCP/IP, IEEE 802.X, GSM, CDMA, LTE, WiMAX, etc. In one embodiment, the mobile skin application 7 may retrieve skins from a remote server through the network interface unit 8.

In one embodiment, the mobile device 1 includes a data interface 22 for coupling to external devices and accessories. The data interface 22 may be wired or wireless and capable of transmitting and receiving images, videos, skins, or other pieces of data to and from external devices and accessories. In a wired configuration, the data interface 22 may be a Universal Serial Bus (USB) interface that is capable of data communications and the transfer of power between the mobile device 1 and an external device or accessory. In a wireless configuration, the data interface 22 may be a Bluetooth transceiver that is capable of data communications and complies with the Bluetooth 2.X or 3.X standards.

In one embodiment, the mobile device 1 includes a location determination unit 9 for determining the location of the mobile device 1. The location determination unit 9 may use a Global Positioning System (GPS) receiver, an assisted GPS system that uses network resources to determine location, or any other similar system or device for establishing the location of the mobile device 1.

In one embodiment, the mobile device 1 includes a Near Field Communications (NFC) transceiver 21 that facilitates short range communications with NFC compliant devices (i.e., devices that comply with ISO/IEC 18092, ISO/IEC 18000-3, ISO 13157, and similar standards). In one embodiment, the NFC transceiver 21 allows the communication of a product identifier, a brand identifier, or a skin after being touched to or coming into close proximity to the product or a product display.

FIGS. 2A, 2B, and 2C show multiple views of the mobile device 1 with a cover 10 according to another embodiment. The mobile device 1 includes the front screen 2A along while the cover 10 adds the rear screen 2B. In this embodiment, the mobile device 1 is identical to the mobile device 1 described above in relation to FIGS. 1A and 1B except for the lack of an integrated rear screen 2B. Instead, the rear screen 2B is integrated into the cover 10. The cover 10 may be coupled to the mobile device 1 through the use clamps, screws, adhesives, or other attachment mechanisms. For example, the mobile device 1 may include a groove that slides into a receiving member of the cover 10 to firmly and securely couple and lock the mobile device 1 to the cover 10.

The cover 10 includes a data interface for communicating with the corresponding data interface 22 of the mobile device 1 such that the mobile device 1 may control and utilize the rear screen 2B integrated in the cover 10 to display images, animations, videos, or other graphics. The data interface of the cover 10 may be a wireless interface, such as a transceiver and antenna that is in compliance with the Bluetooth 2.x or 3.x specifications. In another embodiment, the data interface of the cover 10 may be a wired connector, such as a connector that is in compliance with the Universal Serial Bus (USB) specification and protocol. The USB protocol allows for the data interface of the cover 10 to both facilitate data communications and the transfer of power between the mobile device 1 and the cover 10. In one embodiment, the cover 10 includes a backup battery that may be used to power the mobile device 1 and the rear screen 2B of the cover 10. The cover 10 may include additional circuitry for powering and controlling the rear screen 2B and charging the backup battery.

The cover 10 includes a camera opening 11 for exposing the camera 4 of the mobile device 1. As shown in FIGS. 2B and 2C, the camera opening 11 is elliptical; however, in other embodiments the camera opening 11 may be rectangular, circular, or any other shape that provides an unobstructed view of the rear of the mobile device 1. The camera opening 11 may also expose a flash or another device for providing light during the capturing of images or video by the camera 4. In some embodiment, the cover 10 includes additional openings for exposing buttons, audio ports, microphones, and other areas of the mobile device 1.

The front and rear screens 2A and 2B in both the mobile device 1 in FIGS. 1A and 1C and the mobile device 1 and the cover 10 of FIGS. 2A-2C may use any suitable screen technology that is capable of being integrated into portable personal electronic devices. For example, the front and rear screens 2A and 2B may be liquid crystal displays (LCDs), organic light-emitting diode (OLED) displays, or plasma display panel (PDP) displays. The front screen 2A may be used to primarily display a graphical user interface for operation of the mobile device 1 while the rear screen 2B may be used to primarily display images or animations from a skin as controlled by the mobile skin application 7 to demonstrate a user's affinity for a particular brand or product.

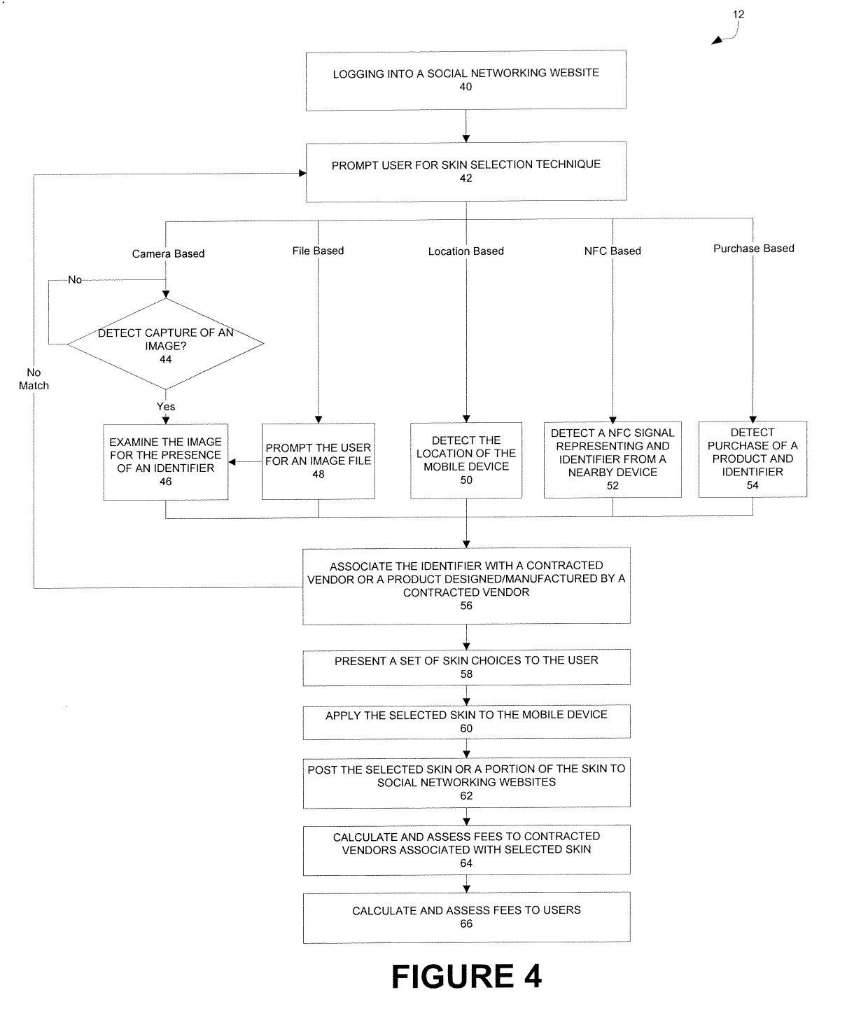

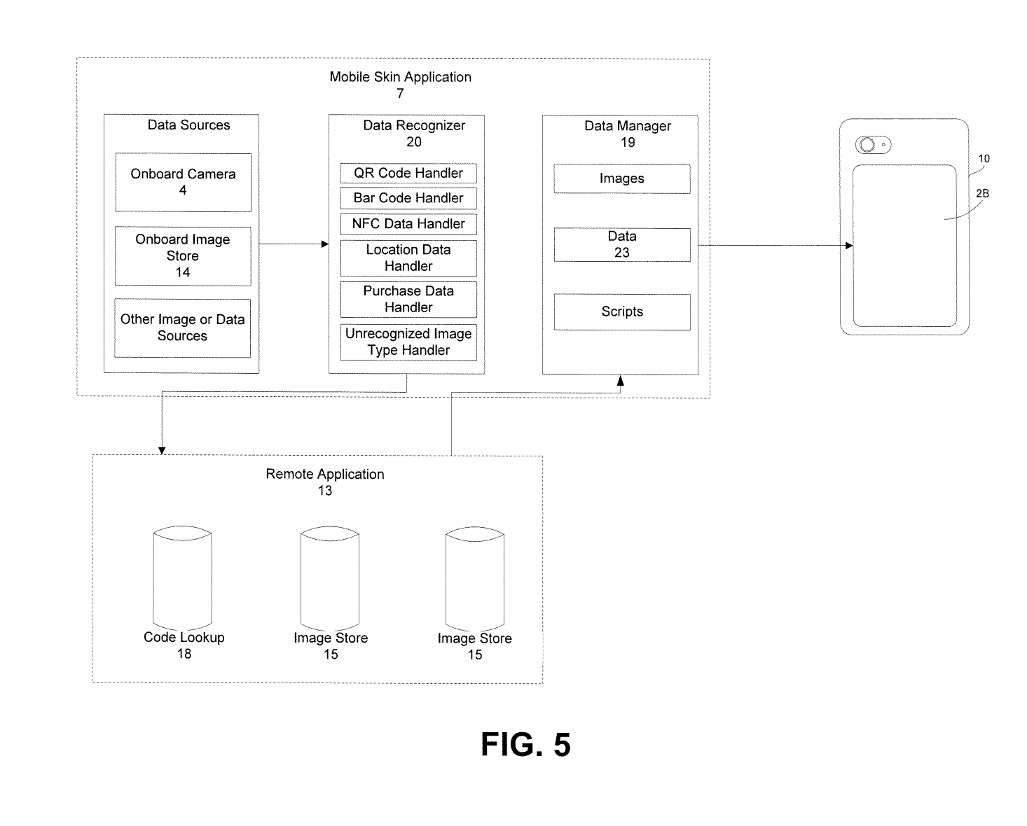

Turning to FIG. 4, a method 12 for applying a skin to the mobile device 1 will now be described. Each operation of the method 12 may be performed by one or more components of the mobile device 1 or the mobile device 1 in conjunction with the cover 10 as shown in FIGS. 1-3. In one embodiment, the method 12 may be fully or partially implemented by the mobile skin application 7 running on the processor 5 integrated in the mobile device 1 and a remote application 13 running on a processor of a remote provider server 16. Example data structures and components of the mobile skin application 7 and the remote application 13 are shown in FIG. 5 and will be described below in conjunction with their function with respect to the method 12.

The method 12 may begin at operation 40 with a user logging into a social networking website. The user may be presented with a graphical user interface on the front screen 2A that requests a username and password for one or more social networking websites. For example, the user may be prompted to login to Facebook, Twitter, MySpace, or any other similar social networking website. The performance of operation 40 may be carried out during configuration of the mobile device 1 or during installation or activation of the mobile skin application 7 on the mobile device 1. Accordingly, a user may enter credentials for logging into a social networking website once and thereafter the mobile skin application 7 and/or the mobile device 1 will login the user automatically without further input. In one embodiment, the user may proceed past operation 40 without logging into a social networking website.

At operation 42, the method 12 prompts the user to choose how a skin for the mobile device 1 is to be selected. In one embodiment, the prompt allows the user to select between 1) camera based skin selection; 2) file based skin selection 3) location based skin selection; 4) Near Field Communication (NFC) skin selection; and 5) purchase based skin selection. Each of these techniques for selecting a skin is described below. The techniques will first be described with respect to their distinctive operations for discovering or receiving identifiers. Thereafter, the operations more common to each technique will be described.

Camera Based Skin Selection

When camera based skin selection is chosen at operation 42, control is moved to operation 44 of the method 12. At operation 44, the method 12 detects when an image is captured by the camera 4. The camera 4 may be a front facing camera or a rear facing camera integrated into the mobile device 1. In one embodiment, operation 44 detects the capture of an image by monitoring an onboard image store 14 for new images or by detecting invocation of a camera application or camera handler. In one embodiment, the an image may be captured using the interface of the mobile skin application 7.

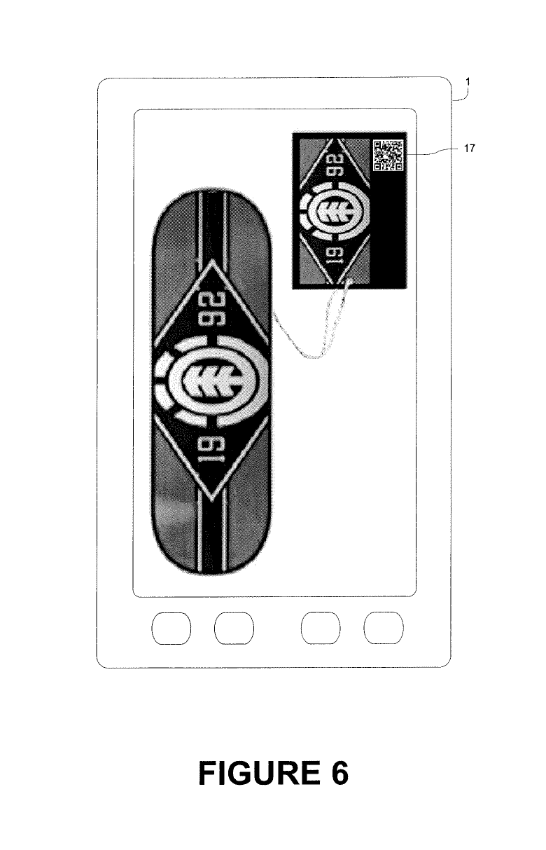

Upon the detection of a captured image at operation 44, the method 12 examines the captured image for the presence of an identifier at operation 46. The identifier may be a Quick Response (QR) code, a barcode, a Microsoft Tag, a text label, a graphic label, or any other similar identifier for identifying the product and/or a vendor that produces the product. FIG. 6 shows an image captured by the camera 4 that includes an identifier 17. In this example, the identifier 17 is a QR code attached to a skateboard. Any method maybe used for detection of an identifier in an image, including object edge detection, changes in lighting and color of objects in the image, and pattern matching techniques. In one embodiment, a data recognizer 20 in the mobile skin application 7 includes separate handlers, functions, or classes for detecting and/or recognizing identifiers. For example, the data recognizer 20 may include separate QR code and barcode handlers for searching for and examining corresponding identifiers in an image.

File Based Selection

When file based skin selection is chosen, operation 48 prompts the user for an image file. The image file may be stored on the mobile device 1 or on a remote device that is accessible over a network connection through the network interface unit 8. For instance, the image file selected by a user may be an image that has been captured by the camera 4 and stored in local memory (e.g., a camera roll or image store) on the device 1 or may be stored remotely on a server (e.g., stored on a file or image sharing website or cloud storage service). Upon choosing an image, the method 12 moves to operation 46 to examine the selected image for the presence of an identifier in a similar fashion as that of the camera based skin selection described above.

Location Based Skin Selection

Upon choosing location based skin selection, operation 50 is performed. Operation 50 detects the location of the mobile device 1. The detected location may include any set of data for indicating location, including a city name, address, and geographical coordinates. In one embodiment, operation 50 is performed by retrieving the mobile device's 1 location from the location determination unit 9. In location based skin selection, the detected location will be used as the identifier for association with a contracted vendor or a product designed/manufactured by a contracted vendor. In one embodiment, the data recognizer 20 may include a location handler for detecting a location of the mobile device 1.

NFC Based Skin Selection

When NFC based skin selection is chosen, operation 52 is performed. Operation 52 detects an NFC signal from a nearby product or device using the NFC transceiver 21 integrated in the mobile device 1. The NFC signal indicates an identifier for a contracted vendor or a product designed/manufactured by a contracted vendor. For example, when a user touches the mobile device 1 to a product, a NFC transmitter integrated or attached to the product may transmit an identifier to the NFC transceiver 21 in the mobile device 1. In one embodiment, the data recognizer 20 may include a NFC handler for detecting an identifier in a NFC signal.

Purchase Based Skin Selection

When purchase based skin selection is chosen, operation 54 is performed. At operation 54, the purchase of a product is detected by the mobile skin application 7 running on a point-of-sale device (e.g., the mobile device 1 using a Square card reader) and an identifier in the purchase is detected. The detected identifier may represent a purchased product or the company of a purchased product. For example, an identifier of a purchased product may be extracted from a receipt or invoice of the transaction. In one embodiment, the data recognizer 20 may include a purchase handler for detecting an identifier in a purchase.

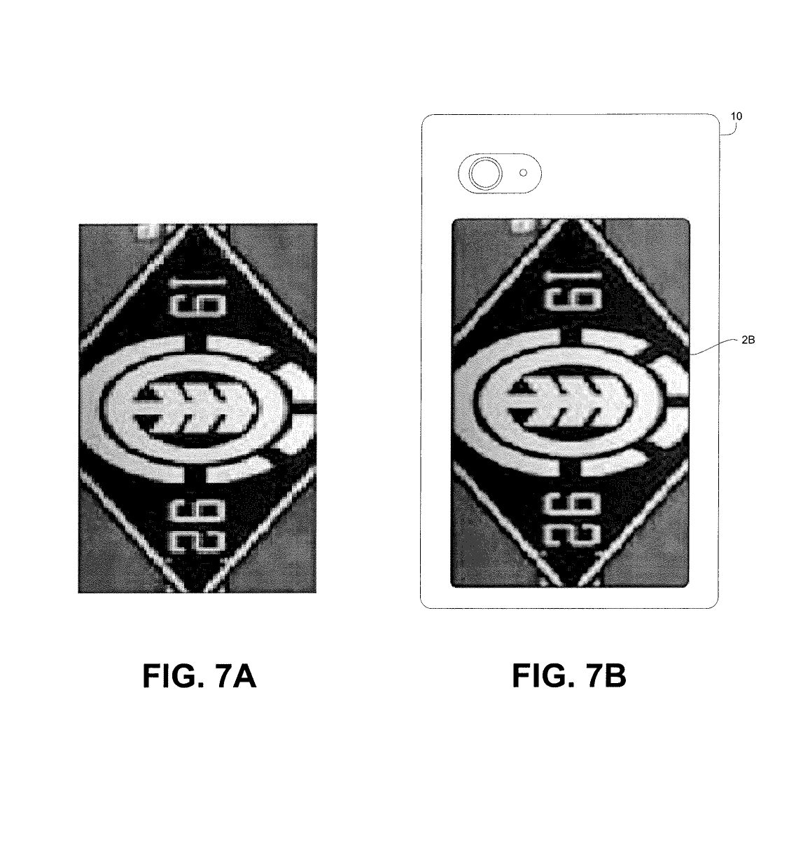

Upon the discovery/receipt of an identifier using any one of the techniques described above, operation 56 attempts to associate the identifier with a contracted vendor or a product designed/manufactured by a contracted vendor. A contracted vendor is a vendor that has contracted with the phone manufacturer or the provider of the mobile skin application 7 (hereinafter “provider”) to deliver skins to users of the mobile skin application 7. In one embodiment, prior to the invocation of the mobile skin application 7, the provider transmits a template to each contracted vendor. The template allows the contracted vendor to design and generate a skin representing their company, brand, or products within the parameters of the mobile device 1. For example, the template may designate a resolution for the rear screen 2B such that images included in a skin conform to the rear screen 2B resolution. FIG. 7A shows an example skin that is generated for the skateboard of FIG. 6 and FIG. 7B shows the skin being used on the rear screen 2B. After the generation of a skin based on the provided template, the contracted vendor transmits the skin to the provider for approval (e.g., transmitted to the remote provider server 16). Upon approval, the skin is stored on the remote provider server 16 and the contracted vendor is issued an identifier to associate with one or more products or other promotional items. For example, as shown in FIG. 6, the identifier issued by the provider may be attached to a product (e.g., a skateboard) such that the identifier may be used to download an associated skin as will be further described below. In one embodiment, the skin is stored in one or more image stores 15 located on the remote provider server 16. In one embodiment, each company and product may have multiple associated skins that may be selected by a user as will be further described below.

As noted above, operation 56 attempts to associate the discovered identifier with a contracted vendor or a product designed/manufactured by a contracted vendor. In one embodiment, operation 56 is performed by comparing the discovered identifier against a set of known identifiers of contracted vendors or products designed/manufactured by contracted vendors. For example, when the discovered identifier is a QR code in an image, the QR code is compared against a set of known QR codes that are associated with products and contracted vendors. In another example, when the identifier is the location of the mobile device 1, the location is compared against a set of known locations of products and companies (e.g., addresses or coordinates of stores). In particular, when the mobile device 1 is located in or near a movie theatre, the discovered identifier (e.g., the location of the mobile device 1) may be associated by operation 56 with a movie, a production company, or movie theatre company. When the mobile device 1 is located in or near a Coach store, the discovered identifier (e.g., the location of the mobile device) may be associated by operation 56 with the contracted vendor Coach and products designed by Coach (e.g., handbags and handbag patterns).

In one embodiment, the comparison between the discovered identifier and the known identifiers is first performed on a local data cache 23 on the mobile device 1. The local data cache 23 is populated by a code lookup data store 18 in the remote application 13 that contains a full listing of identifiers from contracted vendors, whereas the local data cache 23 is a subset of this full listing. The local data cache 23 may be comprised of recently matched identifiers, popularly matched identifiers, or identifiers corresponding to the location and preferences of the user. In one embodiment, the local data cache 23 is controlled by a data manager 19 in the mobile skin application 7. Upon discovering a match in the local data cache 23, a product name/identifier or contracted vendor name/identifier is sent to the remote provider server 16 for retrieval of a corresponding skin or a set of skins using the network interface unit 8.

If a match is not found in the local data cache 23, the mobile skin application 7 may send a request to the remote application 13 to conduct a search using an expanded listing of identifiers in the code lookup data store 18. The request may be transmitted by the network interface unit 8 using one or more wireless protocols, including TCP/IP, IEEE 802.X, GSM, CDMA, LTE, WiMAX, etc. If a match is not found on either the locally stored cache 23 or the code lookup data store 18, the method 12 informs the user of a failure to match and returns to operation 42 to prompt the user to choose a skin selection technique. In one embodiment, an unrecognized image type handler is included in the data recognizer 20 for handling unsupported image formats or identifiers that fail to match with known identifiers types.

After a product or contracted vendor has been successfully associated with the discovered identifier using either the camera based, file based, location based, NFC based, or purchased based techniques discussed above, the method 12 moves to operation 58. At operation 58, a set of skin choices may be presented to the user. The skins are associated with the identified product or contracted vendor, but are aesthetically distinct (i.e., different colors, styles, and/or different resolutions). For example, the presented skins may represent patterns for the identified product or company. The skins may be stored in the local data cache 23 and/or on the remote provider server 16. In one embodiment, operation 58 sends a request to the remote provider server 16 for skins corresponding to the identified product or contracted vendor using the network interface unit 8. The remote provider server 16 may authenticate the request to ensure the mobile device 1 is authorized to receive skins from the provider.

In embodiments in which camera based or file based skin selection is used, the skin choices presented to the user include the original image captured by the camera 4 and detected at operation 44 or selected by a user at operation 48. The skin choices may include different variations or modifications of the original image. For example, a first skin choice may be of the original image converted from color to black and white, a second skin choice may be a cropped version of the original image that focuses on a detected product, and a third skin choice may be an unmodified version of the original image. Other modifications and image processing techniques may be applied to the original image, including color correction/adjustment, brightness adjustment, contrast adjustment, scaling, and noise removal. The modifications made to the original image may be performed by the processor 5 of the mobile device 1 or by the remote provider server 16. In one embodiment, the user may instigate modification of the original image through the mobile skin application 7. For example, the mobile skin application 7 may provide tools that allow the user to modify the original image.

At operation 60, a skin selected by the user at operation 58 is applied to the mobile device 1. The skin may include one or more images, animations, and sounds that may be integrated into the interface of the mobile device 1. For example, the skin may include a background/wallpaper image that is applied to the rear screen 2B of the device 1. In one embodiment, the rear screen 2B of the mobile device 1 is active independent of the front screen 2A. For example, while the mobile device 1 is placing a call and the front screen 2A is turned off, the rear screen 2B may be active and displaying a logo of a contracted vendor (e.g., a Ducati logo) or a design of a particular product (e.g., the design pattern of a particular Cole Haan handbag). This display of a contracted vendor's logo or design allows the user a revolutionary new way to express their personal sense of affinity toward a product, an artist, or an organization by skinning the outward facing rear screen 2B of their mobile device 1 creating walking digital billboards all around the world. Users will instantly be able to transform the look of their mobile device 1 to match their mood, their outfit, their accessories, their favorite music artist, or aid organization, even their mode of transportation to coordinate their mobile device 1 to a product or brand that they identify with.

In other embodiments, application of the skin at operation 60 may change the background image of the front screen 2A, change the appearance style of icons or other interface elements, and change ringtones and sounds effects on the mobile device 1. The elements to be changed at operation 60 may be selected by the user along with selection of a skin at operation 58. For example, the user may select to apply a background image from the skin to the rear screen 2B, but not alter the appearance of the front screen 2A or interface elements.

Following the application of a skin or part of a skin to the mobile device 1, operation 62 prompts the user to post the skin or a portion of the skin (e.g., a cropped version of a background image) to a social networking website. For example, the user may be prompted whether they would like to post the skin to their Facebook wall and/or their Twitter feed. The posting may include one or more images from the skin, text describing the product and/or the contracted vendor, and a link for purchasing the product.

At operation 64 fees may be calculated and assessed to contracted vendors based on the length of use of the skin and the exposure of the skin to third parties. In one embodiment, the calculated fees may include a duration fee that is calculated on a sliding scale based on the duration of time the skin is used on their mobile device 1. For example, for each 24-hour period a background image from the skin is used as background art for the rear screen 2B of the mobile device 1, the provider charges $0.10 to the corresponding contracted vendor. In other embodiments, other monetary and time denominations may be used.

In one embodiment, the calculated fees to contracted vendors may include an exposure fee that measures the response from third parties to the skin. For example, a skin posted to the user's Facebook wall would incur a $0.05 exposure fee for each “like” received, $0.02 for each comment posted in response to the original post, $1.00 for each click of a link in the post to purchase the product, and/or a percentage of the actual purchase price of the product after clicking through the link in the post. In one embodiment, the exposure fee may include additional charges based on the number of friends or followers the user has on the social networking site. For example, a post on a Facebook wall with 200 friends would have a greater exposure fee than a post on a Facebook wall with 100 friends. Accordingly, the exposure fee may be weighted based on the number of friends a user has on a social networking website. For example, the exposure fee may be increased by 10% for each fifty friends over a predefined level (e.g., 100 friends). In one embodiment, the exposure fee is calculated based on actual views or reposts by friends or followers of the user. The calculated fees may be generated and billed to the contracted vendor on a daily, monthly, or quarterly basis.

In one embodiment, the calculated fees to contracted vendors are based on metrics received from social networking websites. For example, the mobile skin application 7 or the remote application 13 may request metrics for a post generated by the method 12. These metrics indicate the exposure of the post created at operation 62 and other statistics on the user's account (e.g., the amount of friends or followers and the amount of visitors to the user's page/wall).

At operation 66, fees may be calculated and assessed to users of the mobile device 1. The fees may be a one-time fee assessed upon a user selecting a skin. For example, each skin presented to the user at operation 58 may have an associated fee that is visible to the user. In one embodiment, the fee may be a donation to a particular organization (e.g., a museum).

In one embodiment, the fee assessed to the user may be based on the length of use of the skin. The calculated fee for the user may be on a sliding scale based on the duration of time the skin is used on the mobile device 1. For example, for each 24-hour period a background image from the skin is used as background art for the rear screen 2B of the mobile device 1, the provider charges $0.25 to the user.

Although described above in relation to purchasable products, the method 12 may function with other items as well. For example, a user may capture an identifier adjacent to a famous painting or photograph in a museum using the camera 4. The identifier is used by the method 12 to transmit a skin to the mobile device 1 corresponding to the painting. In this embodiment, the skin may include an image of the painting scaled and processed for use on the rear screen 2B.

In another embodiment a mobile communications device is provided that, comprises a housing that contains: a front screen located on a front face of the housing; a rear screen located on a rear face of the housing; and a processor running a mobile skin application for applying a skin to the rear screen. In one embodiment, the skin includes an image and the mobile skin application applies the image as a wallpaper for the rear screen. In another embodiment the housing further comprises: a camera for capturing the image. In another embodiment, the housing further comprises: a local data store for storing the image prior to the mobile skin application applying the image to the rear screen. In another embodiment the housing further comprises: a network interface unit for retrieving the image from a remote source. In another embodiment the mobile skin application posts an element of the skin to a social networking website. In still another embodiment the mobile skin application calculates a fee for a user of the device based on use of the skin on the device.

As explained above, an embodiment may be a machine-readable medium (such as microelectronic memory) having stored thereon instructions, which program one or more data processing components (generically referred to here as a “processor”) to perform the operations described above. In other embodiments, some of these operations might be performed by specific hardware components that contain hardwired logic (e.g., dedicated state machines). Those operations might alternatively be performed by any combination of programmed data processing components and fixed hardwired circuit components.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

What is claimed is:

1. A mobile communications device, comprising:
a housing that contains:
a front screen located on a front face of the housing;
a rear screen located on a rear face of the housing;
a camera for capturing an image of a scene that is proximate to the device; and
a processor running a mobile skin application for detecting a identifier in the captured image that is associated with a product or service, and applying a skin associated with the identifier to the device.

2. The mobile communications device of claim 1, wherein the skin includes one or more images representing the product.

3. The mobile communications device of claim 2, wherein the one or more images are applied as background art on the rear screen by the mobile skin application.

4. The mobile communications device of claim 3, wherein the mobile skin application posts an element of the skin, a description of the product, and a link to purchase the product on a social networking website.

5. The mobile communications device of claim 4, wherein the mobile skin application calculates a fee for a vendor of the product based on use of the skin on the device and the posting on the social networking website.

6. The mobile communications device of claim 4, wherein the mobile skin application calculates a fee for a user of the device based on use of the skin on the device.

7. A phone cover, comprising:
an attachment mechanism for holding a phone while exposing a front screen of the phone;
a rear screen for displaying a skin containing an image; and
a data interface for communicating with the phone and allowing the phone to control the rear screen.

8. The phone cover of claim 7, wherein the rear screen is aligned substantially parallel with and directed opposite to the front screen.

9. The phone cover of claim 7, wherein the data interface is a wireless connection.

10. The phone cover of claim 7, further comprising:
a battery for powering the phone and the rear screen.

11. The phone cover of claim 7, further comprising:
a camera opening for exposing a camera of the phone.

12. The phone cover of claim 11, wherein the image is captured by the camera of the phone.

13. The phone cover of claim 7, wherein the image is stored locally on the phone or retrievable from a remote source through a network interface unit integrated in the phone.

14. A method for applying a skin to a rear screen of a mobile device, comprising:
detecting an identifier in an original image;
determining an association between the identifier and a product;
retrieving a skin corresponding to the determined product; and
applying the skin to the rear screen of the mobile device.

15. The method of claim 14, wherein the skin includes a skin image representing the product.

16. The method of claim 15, wherein the skin image representing the product is the original image containing the identifier.

17. The method of claim 15, wherein applying the skin includes applying the skin image as a wallpaper of the rear screen.

18. The method of claim 14, further comprising:
prompting a user to login to a social networking web site; and
posting the skin to the social networking web site, wherein the post includes the skin image, a description of the product, and a link to purchase the product.

19. The method of claim 17, further comprising:
calculating a fee for a vendor of the product based on use and exposure of the skin.

20. The method of claim 17, further comprising:
calculating a fee for the user based on use of the skin.
